(19) United States
(12) Patent Application Publication
(10) Pub. No.: US 2003/0043390 A1
(43) Pub. Date: Mar. 6, 2003

(54) Systems and methods for applying 8-bit alpha blending to bitonal images

(76) Inventors: Terry M. Fritz, Boise, ID (US); Dana A. Jacobsen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/942,074

(22) Filed: Aug. 29, 2001

(51) Int. Cl. H04N 1/405; H04N 1/409; G06T 5/00; G06K 15/00

(52) U.S. Cl. 358/1.9; 358/3.27; 358/3.13

(57) ABSTRACT

Systems and methods are described for applying 8-bit alpha blending to a bitonal source image and a bitonal destination image to produce a bitonal blended image. The bitonal blended image has a high quality, but memory resources are preserved because the process is accomplished without expanding the 1-bit images to 8-bit space before generating the blended image.

### TECHNICAL FIELD

Systems and methods are described herein that relate to applying alpha blending to two or more images. More specifically, the described implementations relate to applying 8-bit alpha blending to 1-bit, or bitonal, images to create a bitonal image.

### BACKGROUND

Dithering is a technique used in computer graphics to create the illusion of varying shades of gray (on a monochrome display or printer) or additional colors (on a color display or printer having limited base colors). Dithering relies on treating areas of an image as groups of dots that are colored in different patterns. Dithering takes advantage of the human eye's tendency to blur spots of different colors by averaging their effects and merging them into a single perceived shade or color. (Dithered images printed by a monochrome printer are also referred to as halftoned images). Depending on the ratio of black dots to white dots within a given area, the overall effect is of a particular shade of gray. Dithering is used to add realism to computer graphics and printed images and to soften jagged edges in curves and diagonal lines at low resolutions.

Dithering is also used to display an image of depth, D, on a display having a depth less than D. For example, an 8-bit image can be dithered to a 1-bit image for display or printing on a 1-bit device. Likewise, an 8-bit image can be dithered to a 2-bit image, and so on.

Alpha blending is a technique of combining multiple source images by taking a weighted average of corresponding pixels in the source images to generate a blended destination image. The two images are blended at a predetermined ratio by executing the following equation for every pixel included in the two images:

P=α·X+(1−α)·Y

where X denotes a digital value of a pixel included in one image, Y denotes a digital value of a pixel included in another image, and a denotes a predetermined blending ratio known as the alpha blending value.

Each pixel in the destination image corresponds to a pixel in each of the source images. The weighted average of a pixel is derived by either by applying a constant alpha blending value to the pixel, or by applying a value from an alpha channel that contains an alpha blending value for each pixel. An alpha channel is a portion of each pixel's data that is reserved for transparency information. For example, in a 32-bit graphics system, each pixel's data contains four channels—three 8-bit channels for red, green, and blue, and one 8-bit alpha channel. The alpha channel is a mask that specified how the pixel's colors should be merged with another pixel when the two are overlaid, one on top of the other. Alpha channel values may vary from pixel to pixel.

As described above, 8-bit alpha blending is typically applied to three-component color format images. In such a case, an 8-bit constant alpha value or an 8-bit-per-pixel alpha channel is applied to two or more 8-bit-per-pixel contone (“continuous tone”) images (as opposed to 1-bit-per-pixel bitonal images). For discussion purposes, further reference will be made to a first source image (“source image”) and a second source image (“destination image”) being blended to produce a third image (“blended image”). To avoid confusion over the use of the term “destination image” for a source image, it should be understood that alpha blending often uses an existing destination image as one of the blend sources, hence the terminology used herein.

For each pixel in the source image (“source pixel”), an 8-bit value is determined. This value ranges from 0 to 255. An 8-bit value of a corresponding pixel in the destination image (“destination pixel”) is then determined. The value of the destination pixel ranges from 0 to 255. An 8-bit alpha value corresponding to the source pixel is then determined. If there is a constant alpha value for the entire source image, the alpha value is the same for each source pixel. If there is an 8-bit-per-pixel alpha channel, then the entry from the alpha channel corresponding to the source pixel is determined. This is the “pixel alpha value,” which ranges from 0 to 255.

A pixel in the blended image (“blended pixel”) that corresponds to the source pixel and the destination pixel can be determined using the three values specified above. The resulting blended pixel has a value from 0 to 255.

Alpha blending typically occurs on contone images as described above, but it is desirable to preserve the blending effects of 8-bit alpha blending using bitonal (1-bit) images. However, problems occur when the source image and the destination image are bitonal (each pixel is either on or off), rather than contone. One proposed solution has been to make an analogous application of the formula described above to bitonal images. Such an application would imply that the pixel alpha value would be snapped to either 0 or 1 by some threshold value. For example, if the pixel alpha value is less than or equal to 128, then the pixel alpha value would become 0. If the pixel alpha value is greater than 128, then the pixel alpha value would become 1. Substituted into the standard formula for alpha blending, the following formula would result: “blended pixel”=(snapped pixel alpha value*source pixel”)+((1−snapped pixel alpha value)*“destination pixel”). However, this solution turns out to be a multiplexing solution rather than a blending solution and yields undesirable visual effects.

To demonstrate the undesirable effects that this creates, consider a line that fades from a pixel value of 255 (black) on the left to a pixel value of 0 (white) on the right. The multiplexing solution results in the left half of the pixels being converted to all 1's (black) and the right half of the pixels being converted to all 0's (white). The result is a line that is half the size of the original line that is a constant black color.

The solution is to first transform the 1-bit images as 8-bit images. Then, the two 8-bit images are combined in a resultant 8-bit image before being re-transformed back to a 1-bit image. There are at least two ways in which the first step can be done. The first solution is to convert the source and destination planes into contone (8-bit) space by changing all values of 1 to values of 255. The other solution is a technique known in the art as “undithering.” Undithering is a technique that transforms 1-bit images into 8-bit images. However, undithering is very complicated and requires a great amount of resources.

After the 1-bit images have been transformed into 8-bit, standard alpha blending is applied to yield a contone blended image, and the blended image can be re-dithered back down to a bitonal image. While this solution may yield acceptable results, a large amount of resource overhead is required, which may be undesirable in many situations.

It is therefore desirable to preserve the 8-bit alpha blending effect on 1-bit images without requiring a large amount of memory or excessive processing time.

### SUMMARY

The systems and methods described herein for applying 8-bit alpha blending to bitonal dithered images provide a way to produce high quality blended bitonal images without consuming large amounts of system resources.

In one implementation described herein, an alpha dither matrix is derived so as to minimize interference patterns created by combining the alpha dither matrix with a source image. In other words, the alpha dither matrix must be chosen to interact optimally with a source dither matrix used to create the bitonal source image. This may be done by rotating the source dither matrix ninety degrees or, preferably, by shifting pixels in the source dither matrix by some x pixels to the right, the shift wrapping the pixels from the right side of the first dither matrix back around to the left side.

In other implementations, the alpha dither matrix is not necessary, as there are other methods known in the art—such as stochastic dithering, error diffusion, etc., to transform an 8-bit image into a 1-bit image. This will be described in greater detail, below. However, the preferred implementation as described herein contemplates utilization of an alpha dither matrix.

A source bitonal mask plane is created by combining an alpha value (from an alpha channel or a constant alpha value) with the alpha dither matrix. Inverting the source bitonal mask plane creates a destination bitonal mask plane. Logically applying (via a logical AND operation) the source bitonal mask plane to the bitonal source image results in a first intermediate value. Logically applying (via a logical AND operation) the destination bitonal mask plane to the bitonal destination image results in a second intermediate value. The bitonal blended image is formed by logically combining (via a logical OR operation) the first intermediate value and the second intermediate value.

The blended image is thus formed from a bitonal source image and a bitonal destination image by applying an 8-bit alpha value. While superior visual results are achieved with other methods known in the art, much less memory is consumed than if the bitonal images were expanded to 8-bit space before applying the alpha value to create the blended image.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a high level diagram of applying 8-bit alpha value(s) to blend two bitonal images.

FIG. 2 is an illustration of a printer system that can be used in accordance with one or more implementations of the invention.

FIG. 3 is a flow diagram of a method of applying 8-bit alpha blending to bitonal images.

### DETAILED DESCRIPTION

The invention is illustrated in the drawings as being implemented in a suitable computing environment. Although not required, the invention will be described in the general context of computer-executable instructions, such as program modules, to be executed by a computing device, such as a personal computer or a printing device. Generally, program modules include routines, programs, objects, components, data structures, etc., that perform particular tasks or implement particular abstract data types. Moreover, those skilled in the art will appreciate that the invention may be practiced with other computer/printer configurations, including microprocessor-based or programmable consumer electronic appliances, display devices, and the like.

General reference is made herein to one or more printing devices. As used herein, “printing device” means any electronic device having data communications and data storage capabilities that functions to render printed characters, images, vectors, lines, etc. on a print medium. The term “printing device” includes, but is not limited to, printers, copiers, facsimile machines and plotters. The term “printer” includes, but is not limited to, laser printers, ink jet printers, dot matrix printers, dry medium printers and the like. Although specific examples may refer to one or more of these printing devices, such examples are not meant to limit the scope of the claims or the description, but are meant to provide a specific understanding of the described implementations.

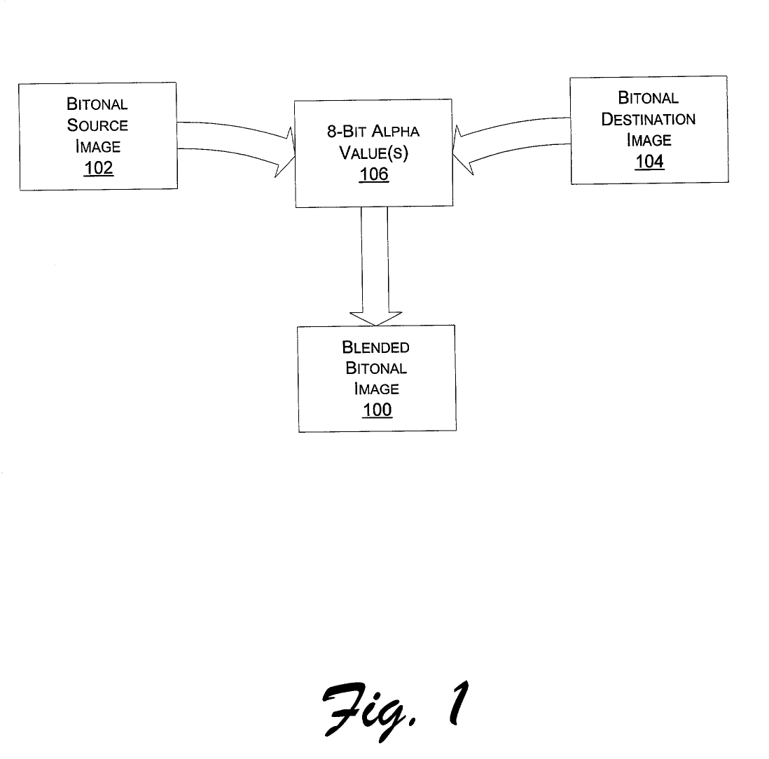

FIG. 1 is a general high level diagram showing an 8-bit alpha value applied to bitonal source images to derive a bitonal blended image. Although the present discussion will focus on 1-bit source images and an 8-bit alpha value, it is noted that the invention may be implemented with source images of a first bit depth and an alpha value of a second bit depth, wherein the second bit depth is greater than the first bit depth. For example, the source images may be 8-bit images where the alpha value(s) are 24-bit values, etc.

A blended image 100 is derived by calculating a blended pixel value for each pixel contained in the blended image. A source image 102 and a destination image 104 correspond, pixel for pixel, to the blended image 100. In a typical alpha blending process, a weighted average is derived for each pixel in the blended image 100 from the corresponding pixels in the source image 102 and the destination image 104. This is accomplished using an alpha blending value 106 in the following equation:

P=α·X+(1−α)·Y

wherein X denotes a digital value of a pixel included in the source image 102, Y denotes a digital value of a pixel included in the destination image, a denotes a predetermined blending ratio for X and Y (the alpha blending value 106), and P denotes a digital value of a pixel included in the blended image that corresponds to X and Y. The alpha blending value 106 is either a value that is constant for each pixel in the images, or the alpha blending value 106 comes from an alpha channel that contains an alpha blending value for each pixel in the images. The alpha blending values 106 may vary from pixel to pixel in the images.

It is significant to note that, in FIG. 1, the source image 102 and the destination image 104 are bitonal (1-bit) images and the alpha values 106 are 8-bit values. This is significant because the typical application of 8-bit alpha blending is to apply the alpha values to an 8-bit source image and an 8-bit destination image to derive an 8-bit blended image. In the present case, the source image 102 and the destination image 104 are bitonal, i.e., 1-bit images, I while the alpha values 106 are 8-bit values. The 8-bit alpha values 106 cannot be applied to the bitonal source image and the bitonal destination image without first applying some pre-blending calculations. The implementations described herein apply blending calculations to the 1-bit images without first expanding the 1-bit images to 8-bit space. This preserves the visual quality of the blending procedure while preserving memory resources. The resultant image is a bitonal (1-bit) image.

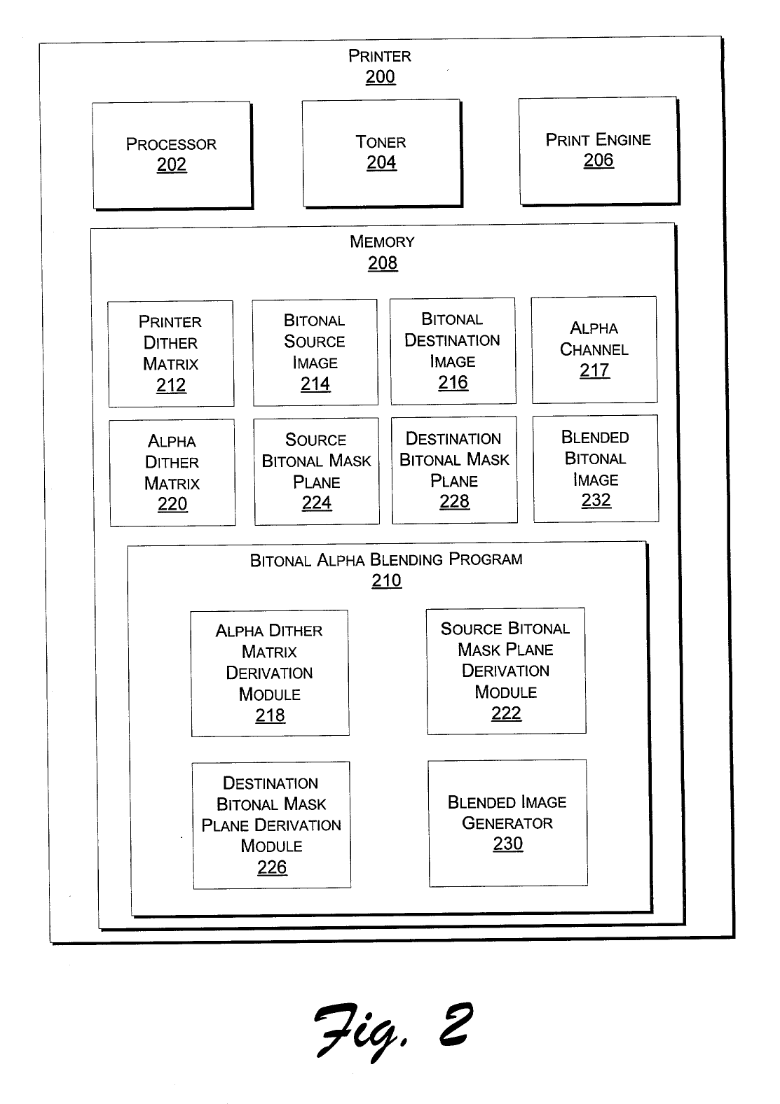

FIG. 2 depicts a printer system generally at 200 that includes a processor 202, toner 204, a print engine 206, and memory 208. A bitonal alpha blending program 210 (“blending program”) is stored in the memory 208. The blending program 210 comprises a set of processor-executable instructions that are executable on the processor 202 to derive a blended image from two or more source images.

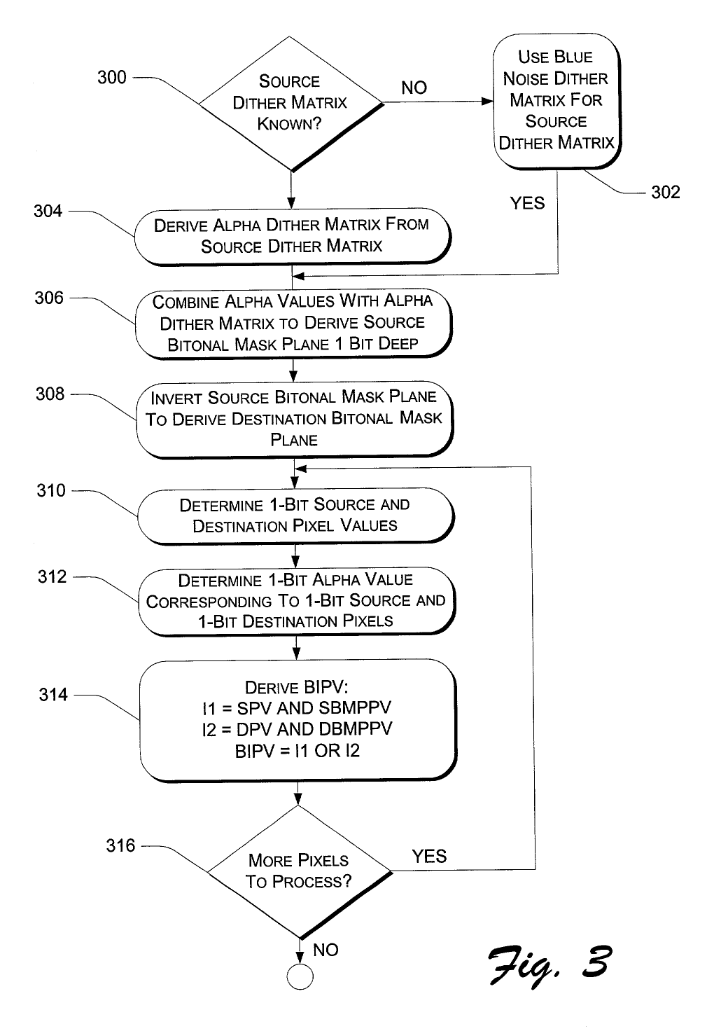

A printer dither matrix 212 is stored in the memory, usually at the time Hi of manufacture. It is noted that the printer dither matrix 212 may also be referred to herein as a “source dither matrix” when referring to an implementation of a source dither matrix in a non-printing environment, since the invention(s) described herein might be used in a printing device or in a non-printing environment. A “source dither matrix” may also be used in a printing environment, if a dither matrix other than the printer dither matrix is used in the process. Therefore, the term source dither matrix and the term printer dither matrix are virtually interchangeable. For the most part, the term “printer dither matrix” will be used herein as FIG. 2 and FIG. 3 describe a printing device.

The printer manufacturer considers the toner 204, the print engine 206, how a printer laser (not shown) reacts with the toner 204 and print medium (not shown), and various other printer factors when determining the optimal printer dither matrix to use in the printer 200. The printer dither matrix 212 is relatively permanent and is typically stored in a non-volatile portion (not shown) of the printer memory 208. However, it is not unusual for the default printer—or source—dither matrix to be replaced by a different printer matrix.

A bitonal source image 214 and a bitonal destination image 216 are stored in the memory 208. The destination image 216 is typically a print buffer, which contains an aggregate image during a printing process before a final image is output to a print medium. The destination image 216 is initially all white (all zeroes) and will accumulate buffered output as the printing process progresses. An alpha channel 217 is received with the image data and is stored in the memory 208. The alpha channel 217 contains an alpha value that corresponds to each pixel comprising the bitonal source image 214 (and, thus corresponding also to each pixel in the bitonal destination image 216). Although the printer 200 is shown having an alpha channel 217 having a unique alpha value corresponding to each pixel, it is noted that a constant alpha value (not shown) could be used to initialize the alpha channel 217, i.e., the alpha channel 217 is constructed from the constant alpha value.

An alpha dither matrix derivation module 218 is included in the blending program 210 and is configured to derive an alpha dither matrix 220 from the printer dither matrix 212. The alpha dither matrix 220 is chosen to minimize the interference patterns created by combining a bitonal mask plane created with the alpha dither matrix 220 and the bitonal source image 214. To this end, the alpha dither matrix 220 and the printer dither matrix 212 (which is used to dither the bitonal source image 214) must be configured in a pixel-orthogonal manner so that when blending a gray image created using the alpha dither matrix 220 with a gray image created using the printer dither matrix 212, the result does not turn out to be all white, all black, or undesirably clustered. Optimally, the pixels in the printer dither matrix 212 and the alpha dither matrix 220 should not have high correlation.

In one implementation, the alpha dither matrix 220 is derived by rotating the printer dither matrix 212 by ninety degrees (90°). This usually gives an acceptable alpha dither matrix 220, though usually not optimal. In a preferred implementation, the pixels of the printer dither matrix 212 are shifted in one direction by a certain number of pixels, with pixels that are shifted out of the matrix being wrapped around to the other side of the matrix. For example, the alpha dither matrix 220 can be derived by shifting the pixels in the printer dither matrix 212 five (5) pixels to the right. Any pixels shifted off the right margin of the printer dither matrix 212 are wrapped around to the left side of the printer dither matrix 212.

Almost any constant may be used in the shifting process. Some numbers will provide better results than others. The shifting constant cannot be a multiple of the width of the printer dither matrix 212 or the results will be identical and, therefore, undetectable. For instance, if the printer dither matrix 212 is a 12-pixel-by-12-pixel dither matrix and the pixels are shifted by twelve or twenty-four pixels to the right, the wraparound will cause the pixels to be “shifted” back to their original position and the alpha dither matrix 220 will be identical to the printer dither matrix 212, which will produce unacceptable results. The preferred constant is a function of the contents of the printer dither matrix 212.

Careful selection of the printer dither matrix 212 and the alpha dither matrix 220 is necessary to avoid significant visual interference patterns. In one implementation, a clustered-dot dither matrix is used as the printer dither matrix 212 and a blue noise dither matrix is used as the alpha dither matrix 220. Other dither matrices can be used for both the source dithering and the alpha dithering as long as they do not have significant visual interference patterns. If the source dither matrix is unknown, a blue noise dither matrix, an error diffusion technique, or any other acceptable technique known in the art would be appropriate.

The blending program 210 also includes a source bitonal mask plane derivation module 222, which is configured to combine the alpha channel 217 with the alpha dither matrix 220 to produce a source bitonal mask plane 224, which is stored in the memory 208. As will be described in greater detail below, the source bitonal mask plane 224 is used to combine with the bitonal source image 214 in later processing.

The blending program 210 further includes a destination bitonal mask plane derivation module 226 that produces a destination bitonal mask plane 228 from the source bitonal mask plane 224. In the preferred implementation, this is accomplished by inverting the source bitonal mask plane 224 to derive the destination bitonal mask plane 228. As will be discussed in greater detail, below, the destination bitonal mask plane 228 is used with the bitonal destination image 216.

The blending program 210 includes a blended image generator 230, which is configured to produce a bitonal blended image 232 using the bitonal source image 214, the source bitonal mask plane 224, the bitonal destination image 216 and the destination bitonal mask plane 228. Since the alpha channel 217 was used in the production of the source and destination bitonal mask planes 224, 228, the alpha blending effect will be preserved even though the 1bit source and destination images 214, 216 always remained in a 1-bit plane, i.e., the images were not expanded to an 8-bit plane to be combined directly with the alpha channel 217. The specifics of how the blended image 232 is produced by the blended image generator 230 will be discussed in detail, below, with reference to FIG. 3.

FIG. 3 is a flow diagram of a method for applying an 8-bit alpha blending channel to bitonal images. For purposes of discussion, continuing reference will be made to the elements and reference numerals of FIG. 2.

It is determined (block 300) whether the source (printer) dither matrix (212) to be used is known. (As previously discussed, the implementation described herein may be applied to a non-printing environment. If so, then what is termed the “printer dither matrix” may be better described as the “source dither matrix.”) Also, the term “source dither matrix” may apply to a printing environment, since a dither matrix other than the printer dither matrix 212 may be used in place of the printer dither matrix 212. In a printing environment, the printer dither matrix 212 is used if no other source dither matrix is specified. For the purposes of FIG. 3, the term “source dither matrix” will be used.

If the source dither matrix 212 is not known (“No” branch, block 300), then a blue noise matrix or some other suitable matrix is used (block 302). If the source dither matrix 212 is known (“Yes” branch, block 300), then the process continues at block 304, wherein the alpha dither matrix 220 is derived from the printer dither matrix 212 by shifting the pixels of the printer dither matrix 212 some x pixels to the right, with pixels shifted off the right margin of the printer dither matrix 212 wrapping around to the left side of the matrix. It is noted that the shift is not limited to a “right shift.” The pixels may be shifted up, down, left, right or a combination thereof. For example, the pixels may be shifted three columns to the right and five rows down. Preferably, the pixels are shifted an odd number of rows and/or columns.

The alpha values from the alpha channel 217 are combined with the alpha dither matrix 220 at block 306 to create the source bitonal mask plane 224. At block 308, the source bitonal mask plane 224 is inverted to create the destination bitonal mask plane 228.

Block 310 and block 312 are performed for each pixel in the bitonal source image 214 (and, thus, each pixel in the bitonal destination image 216 and the bitonal blended image 232). At block 310, a 1-bit pixel value is determined for corresponding pixels in the bitonal source image 214 and the bitonal destination image 216. At block 312, a 1-bit alpha value corresponding to the 1-bit pixel values in the source and destination images is determined.

A blended pixel value in the bitonal blended image 232 is derived at block 314 from the corresponding source pixel value (SPV), destination pixel value (DPV), source bitonal mask plane pixel value (SBMPPV) and destination bitonal mask plane pixel value (DBMPPV).

Block 314, in more detail, consists of deriving a first intermediate value (I1) by applying a logical AND operation to the source pixel value (SPV) and the source bitonal mask plane pixel value (SBMPPV). A second intermediate value (I2) is derived by applying a logical AND operation to the destination pixel value (DPV) and the destination bitonal mask plane pixel value (DBMPPV). The corresponding blended image pixel value (BIPV) in the bitonal blended image 232 is found by logically combining (OR'ing) the first intermediate value and the second intermediate value.

At block 316, if there are more pixels in the bitonal source image 214 and the bitonal destination image 216 to process (“YES” branch, block 316), then the process repeats from block 310. If there are no more pixels to process (“NO” branch, block 316), then the process concludes and the bitonal blended image 232 is output for final processing. Final processing may include printing the bitonal blended image on a print medium or, in a system having an output display instead of a printer, outputting the bitonal blended image 232 to a display.

Conclusion

The desirable effects of 8-bit alpha blending are thus preserved without requiring excessive memory space by first expanding the 1-bit source and destination images to 8-bit space, blending the images, and reducing the blended image to 1-bit space. Therefore, the process provides the same or higher quality results than what is currently known in the art while saving valuable system resources. The described implementations can be utilized with a printer, as described, or with a different type of printing device, or with a device having a display where it is desirable to blend two images of a given bit depth using one or more alpha values of a greater bit depth.

Although the implementation described herein have been described in language specific to structural features and/or methodological steps, it is to be understood that the invention defined in the appended claims is not necessarily limited to the specific features or steps described. Rather, the specific features and steps are disclosed as preferred implementations.

1. A method, comprising:
determining a source pixel value of a first bit depth for a source pixel in a source image;
determining a destination pixel value of the first bit depth for a destination pixel in a destination image, the destination pixel corresponding to the source pixel;
deriving a blended pixel value of the first bit depth for a blended pixel in a blended image by applying an alpha value of a second bit depth to the source pixel value and the destination pixel value without converting the pixel values to the second bit depth; and
wherein the second bit depth is greater than the first bit depth.

2. The method as recited in claim 1, further comprising:
deriving an alpha dither matrix from a source dither matrix;
combining one or more alpha values associated with the source image with the alpha dither matrix to derive a source bitonal mask plane;
deriving a destination bitonal mask plane from the source bitonal mask plane; and
wherein the deriving the blended pixel value further comprises deriving the blended pixel value from the source pixel value, the source bitonal mask plane, the destination pixel value and the destination bitonal mask plane.

3. The method as recited in claim 2, wherein a stochastic technique is used to derive the alpha dither matrix when the source printer matrix is unknown.

4. The method as recited in claim 2, wherein the alpha dither matrix is derived from the source dither matrix by rotating the source dither matrix.

5. The method as recited in claim 2, wherein the alpha dither matrix is derived from the source dither matrix by performing a wraparound shift on pixels in the source dither matrix.

6. The method as recited in claim 2, wherein the alpha dither matrix is derived from the source dither matrix by shifting pixels in the source dither matrix a constant number of pixel positions.

7. The method as recited in claim 6, wherein the constant number of pixels is an odd number of pixels that is not a multiple of a dimension of the source dither matrix, the dimension being height or width, depending on the direction of the shift.

8. The method as recited in claim 2, wherein the one or more alpha values associated with the source image is an alpha value that is constant for each pixel in the source image.

9. The method as recited in claim 2, wherein the one or more alpha values associated with the source image are multiple alpha values from an alpha channel that includes an alpha value for each pixel in the source image.

10. The method as recited in claim 2, wherein the source bitonal mask plane is inverted to derive the destination bitonal mask plane.

11. The method as recited in claim 2, wherein deriving the blended pixel value further comprises:
(a) logically applying a source bitonal mask plane pixel value from the source bitonal mask plane to the source pixel value;
(b) logically applying a destination bitonal mask plane pixel value from the destination bitonal mask plane to the destination pixel value; and
(c) logically combining the results of (a) and (b).

12. The method as recited in claim 2, wherein deriving the blended pixel value further comprises:
deriving a first intermediate value by performing a logical AND operation with the source pixel value and the source bitonal mask plane;
deriving a second intermediate value by performing a logical AND operation with the destination pixel value and the destination bitonal mask plane; and
deriving the blended pixel value by performing a logical OR with the first intermediate value and the second intermediate value.

13. A computer-readable medium containing computer-executable instructions that, when executed on a computer, perform the method recited in claim 1.

14. A printing device containing processor-executable instructions that, when executed on a processor in the printing device, perform the method recited in claim 1.

15. An electronic appliance having a display and processor-executable instructions that, when executed on a processor in the electronic appliance, perform the method recited in claim 1.

16. A system, comprising:
memory;
a processor;
a source image stored in the memory, the source image consisting of multiple source pixels, each source pixel having a source pixel value of a first bit depth;
a destination image stored in the memory, the destination image consisting of multiple destination pixels, each destination pixel having a destination pixel value of the first bit depth;
one or more alpha values having a second bit depth stored in the memory;
a source dither matrix stored in the memory;
an alpha dither matrix derivation module configured to derive an alpha dither matrix from the source dither matrix;
a source mask plane derivation module configured to create a source mask plane of the first depth from the one or more alpha values and the alpha dither matrix;
a destination mask plane derivation module configured to create a destination mask plane of the first depth from the source bitonal mask plane; and
a blended image generator configured to create a blended image of the first bit depth from the source image, the destination image, the source mask plane and the destination mask plane, without converting the images to the second bit depth.

17. The system as recited in claim 16, wherein the first bit depth is one bit and the second bit depth is eight bits.

18. The system as recited in claim 16, further comprising a print engine configured to print the blended bitonal image on a print medium.

19. The system as recited in claim 16, further comprising an output module configured to output the blended bitonal image to a video display.

20. The system as recited in claim 16, wherein the one or more alpha values further comprise multiple alpha values in an alpha channel.

21. The system as recited in claim 16, wherein the destination mask plane derivation module is further configured to create a destination mask plane of the first depth by inverting the source bitonal mask plane.

22. The system as recited in claim 16, wherein the blended image generator is further configured to:
create a first intermediate value by logically applying the source mask plane to the source image;
create a second intermediate value by logically applying the destination mask plane to the destination image; and
create the blended image by logically combining the first intermediate result with the second intermediate result.

23. A method for applying an 8-bit alpha channel to a bitonal source image and a bitonal destination image to create a blended bitonal image, the method comprising:
deriving an alpha dither matrix from a source dither matrix;
combining alpha values from the alpha channel with the alpha dither matrix to derive a source bitonal mask plane;
inverting the source bitonal mask plane to derive a destination bitonal mask plane;
applying the source bitonal mask plane to the bitonal source image to derive a first intermediate value;
applying the destination bitonal mask plane to the bitonal destination image to derive a second intermediate value;
logically adding the first intermediate value and the second intermediate value to derive the blended bitonal image.

24. The method as recited in claim 23, wherein deriving the alpha dither matrix further comprises uniformly shifting pixels vertically in the source dither matrix by a constant amount that is not a multiple of a height of the source dither matrix.

25. The method as recited in claim 23, wherein deriving the alpha dither matrix further comprises uniformly shifting pixels horizontally in the source dither matrix by a constant amount that is not a multiple of a width of the source dither matrix.

26. A printer configured to perform the method as recited in claim 23.

27. The method as recited in claim 23, wherein deriving the alpha dither matrix further comprises uniformly shifting pixels horizontally and vertically in the source dither matrix by a constant amount that is not a multiple of a width or height of the source dither matrix.
